(19) United States
(12) Patent Application Publication
(10) Pub. No.: US 2012/0051915 A1
(43) Pub. Date: Mar. 1, 2012

(54) PLANETARY GEAR TRAIN WITH IMPROVED BEARING STRUCTURE AND MANUFACTURE METHOD OF THE SAME

(75) Inventors: Kazutaka suzuki, Tokyo (JP); Kazufumi TAKAYANAGI, Tokyo (JP); Takafumi YOSHIDA, Tokyo (JP); Hideaki NISHIDA, Tokyo (JP); Motohisa UESATO, Aichi (JP); Masahiro KUSAKA, Aichi (JP)

(73) Assignee: MITSUBISHI HEAVY INDUSTRIES, LTD., Tokyo (JP)

(21) Appl. No.: 13/024,734

(22) Filed: Feb. 10, 2011

Related U.S. Application Data
(63) Continuation of application No. PCT/JP2010/064788, filed on Aug. 31, 2010.

(51) Int. Cl. F03D 11/02; F16C 23/02; B23P 11/00; F16H 57/08

(52) U.S. Cl. 416/170 R; 475/331; 384/416; 29/893.1

(57) ABSTRACT

A planetary gear train is provided with a planetary gear and a planetary pin inserted into the planetary gear. The planetary gear includes: a gear member having teeth on the outer face and a through hole; an intermediate housing inserted into the through hole and having an insert hole into which the planetary pin is inserted; and a plurality of sliding bearing members jointed onto the insert hole of the intermediate housing. The plurality of sliding bearing members form a sliding bearing which sustains the planetary pin and the planetary gear to be rotatable with each other.

### CROSS-REFERENCE TO RELATED APPLICATION

This application is a continuation of International Application No. PCT/JP2010/064788, filed on Aug. 31, 2010.

### BACKGROUND OF THE INVENTION

1. Field of the Invention

The present invention relates to a planetary gear train, a bearing structure, and a wind turbine generator using the same, more particularly, to a bearing structure suitable for a planetary gear of the planetary gear train.

2. Description of the Related Art

The planetary gear train is one of mechanisms widely used as step-up gear boxes and a reduction gear boxes. The planetary gear train has an advantage that a large reduction ratio can be obtained with a reduced number of gears and a large torque can be transferred. Such an advantage is preferable for a wind turbine generator, and the planetary gear train is widely used as the step-up gear box of the wind turbine generator.

One problem in applying a planetary gear train to a wind turbine generator is the lifetime of bearings of the planetary gears. When a planetary gear train is used as the gear box of the wind turbine generator, large loads are applied to the bearings of the planetary gears. Currently, rolling bearings are often used as the bearings of the planetary gears in the planetary gear train; however, the lifetime thereof will be reduced when large loads are applied to the rolling bearings. The increase in the load is a serious problem, especially in high-power wind turbine generators which have been recently developed.

The inventors have been considering using sliding bearings as bearings provided on the inner faces of the planetary gears as an approach for achieving a long lifetime and a reduced size of the bearings of the planetary gears. The sliding bearing can sustain the large load, since receiving the load with fluid oil film pressure. Use of sliding bearings, which can sustain a large load, may make it possible to realize a maintenance-free planetary gear train.

In the use of the sliding bearing, choice of material and structure greatly influences the lifetime. Especially for a sliding bearing applied to a planetary gear of a planetary gear train of machinery subjected to an extraordinary large load, such as a wind turbine generator, it is required to choose the material and structure so as to bear the load. For example, a sliding bearing with a structure in which a surface layer made of PEEK (polyetheretherketone) material or other materials is backed up by a back metal is one of sliding bearing structures capable of bearing a large load.

On the other hand, a sliding bearing capable of bearing a large load may have a restriction in the formable shape in some cases, and this may cause difficulty in the assembly to the planetary gear. For example, manufacture of a sliding bearing of the above-mentioned structure in which the surface layer made of PEEK (polyetheretherketone) material or other materials is backed up by a back metal, especially when the sliding bearing is large, may cause difficulty in forming into a cylindrical shape (or bush) in aspects of the technology and the cost, and accordingly the sliding bearing having such structure is, for example, formed in a half cylindrical shape. On the other hand, there is a difficulty in assembling a sliding bearing formed in a half cylindrical shape onto the inner face of a planetary gear. The assembly of a bearing onto the inner face of the planetary gear is generally achieved by shrink fitting; however, a sliding bearing formed in a half cylindrical shape cannot be assembled with shrink fitting. Meanwhile, it is not preferable that a sliding bearing is jointed onto the inner face of the planetary gear by welding, since heat is partially applied to the planetary gear to cause thermal deformation and the sliding bearing cannot be replaced. The restriction in the shape of the sliding bearing member is also described in Japanese Patent Application Publication No. JP-A H11-201167.

### SUMMARY OF INVENTION

Therefore, an objective of the present invention is to provide a technique for achieving assembly of a sliding bearing having a restriction in the formable shape as a bearing of a planetary gear.

In an aspect of the present invention, a planetary gear train is provided with: a planetary gear; and a planetary pin inserted into the planetary gear. The planetary gear includes: a gear member having teeth formed on the outer face and provided with a through hole; an intermediate housing inserted into the through hole and having an insert hole into which the planetary pin is inserted; and a plurality of sliding bearing members jointed onto the insert hole of the intermediate housing. The plurality of sliding bearing members form a sliding bearing which sustains the planetary pin and the planetary gear to be rotatable with each other.

In one embodiment, the intermediate housing and the sliding bearing member are jointed so as not to be detachable, and the planetary gear and the intermediate housing are jointed so as to be detachable. Here, it is preferable that the intermediate housing and the sliding bearing member are welded and the planetary gear and the intermediate housing are jointed with shrink fitting.

It is preferable that the intermediate housing includes at least one thrust pad serving as a thrust bearing provided on a surface opposed to a carrier which is jointed to the planetary pin. When a plurality of thrust pads are provided, it is preferable that the thrust pads are circumferentially arranged to be separated from each other.

In another aspect of the present invention, a bearing structure is provided with: an intermediate housing to be inserted into a through hole provided through a gear member having teeth formed on the outer surface thereof and having an insert hole into which a pin is inserted; and a plurality of sliding bearing members jointed onto the insert hole of the intermediate housing. The plurality of sliding bearing members form a sliding bearing.

In still another aspect of the present invention, a wind turbine generator is provided with: a wind turbine rotor including a rotor head and a wind turbine blade coupled to the rotor head; a gear box including an input shaft jointed to the rotor head; and a generator jointed to an output shaft of the gear box. The gear box includes a planetary gear train. The planetary gear train includes: a planetary gear; and a planetary pin inserted into the planetary gear. The planetary gear includes: a gear member having teeth formed on the outer face thereof and provided with a through hole; an intermediate housing inserted into the through hole and having an insert hole into which the planetary pin is inserted; and a plurality of sliding bearing members jointed onto the insert hole of the intermediate housing and arranged in a circumferential direction of the planetary pin. The plurality of sliding bearing members form a sliding bearing which sustains the planetary pin and the planetary gear to be rotatable with each other.

In further another aspect of the present invention, a manufacture method of a planetary gear having a structure in which a planetary pin is inserted through an insert hole of a planetary gear train is provided. The manufacture method includes steps of: providing an intermediate housing through which the insert hole is provided; jointing a plurality of sliding bearing members onto the insert hole of the intermediate housing, the sliding bearing members forming a sliding bearing; and fitting the intermediate housing into a through hole of a gear member having teeth formed on the outer face. In one embodiment, the intermediate housing and the sliding bearing member are jointed so as not to be detachable, and the planetary gear and the intermediate housing are jointed so as to be detachable. Here, it is preferable that the intermediate housing and the sliding bearing member are welded and the planetary gear and the intermediate housing are jointed with shrink fitting.

The present invention allows assembling a sliding bearing having a restriction in the formable shape as the bearing of a planetary gear.

### BRIEF DESCRIPTION OF THE DRAWINGS

FIG. 1 is an outline view showing the configuration of a wind turbine generator to which a planetary gear train of one embodiment of the present invention is applied;

FIG. 2 is a perspective view showing the internal structure of a nacelle in one embodiment of the present invention;

FIG. 3 is a cross sectional view showing the structure of a gear box in one embodiment of the present invention;

FIG. 4 is a front view showing the structure of a planetary gear in one embodiment of the present invention;

FIG. 5 is a cross sectional view showing the structure of the planetary gear according to one embodiment of the present invention; and

FIG. 6 is a partial cross sectional view showing the structure of an intermediate housing in one embodiment of the present invention.

### DESCRIPTION OF PREFERRED EMBODIMENTS

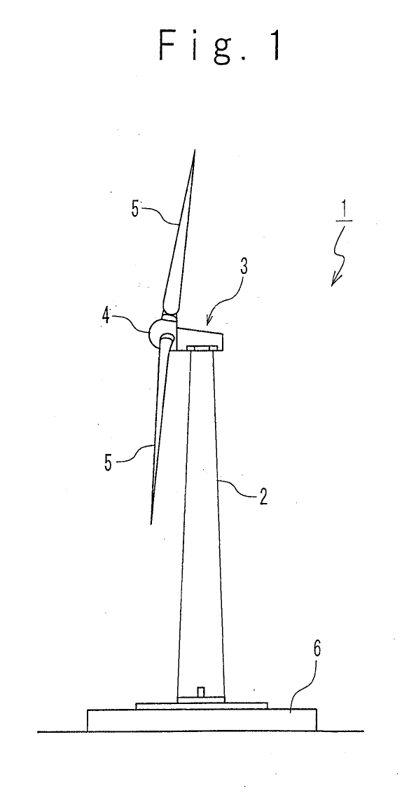

FIG. 1 is an outline view showing the configuration of a wind turbine generator utilizing a planetary gear train of one embodiment of the present invention. A wind turbine generator 1 is provided with a tower 2 stood on a base 6, a nacelle 3 installed on the top of the tower 2, a rotor head 4 rotatably attached to the nacelle 3, and wind turbine blades 5 attached to the rotor head 4. The rotor head 4 and the wind turbine blades 5 form a wind turbine rotor.

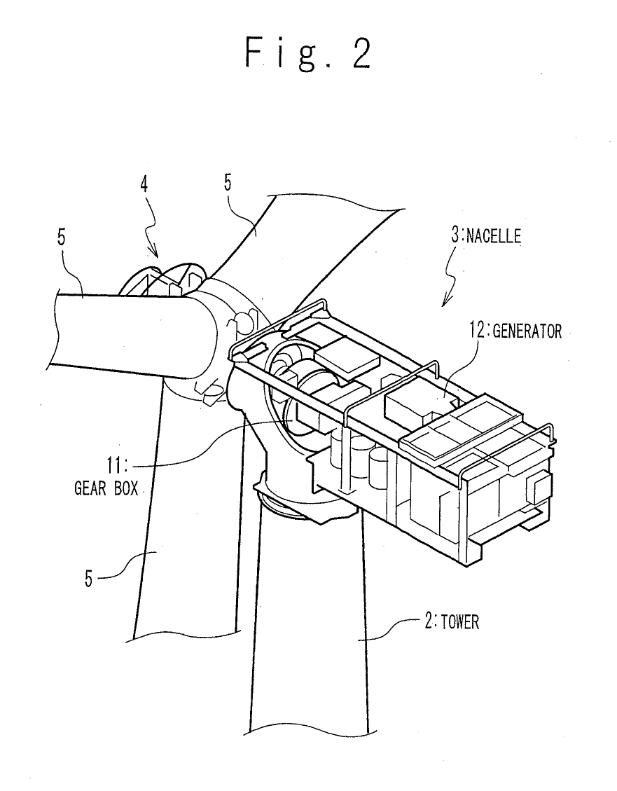

As shown in FIG. 2, a gear box 11 and a generator 12 are provided inside the nacelle 3. The input shaft of the gear box 11 is coupled to the main shaft (not shown in the drawing) of the rotor head 4, and the output shaft of the gear box 11 is coupled to the rotor of the generator 12. When the rotor head 4 is rotated by wind power, the rotation thereof is stepped up by the gear box 11 and transferred to the rotor of the generator 12, so that the generator 12 is driven. As a result, electric power is obtained from the generator 12.

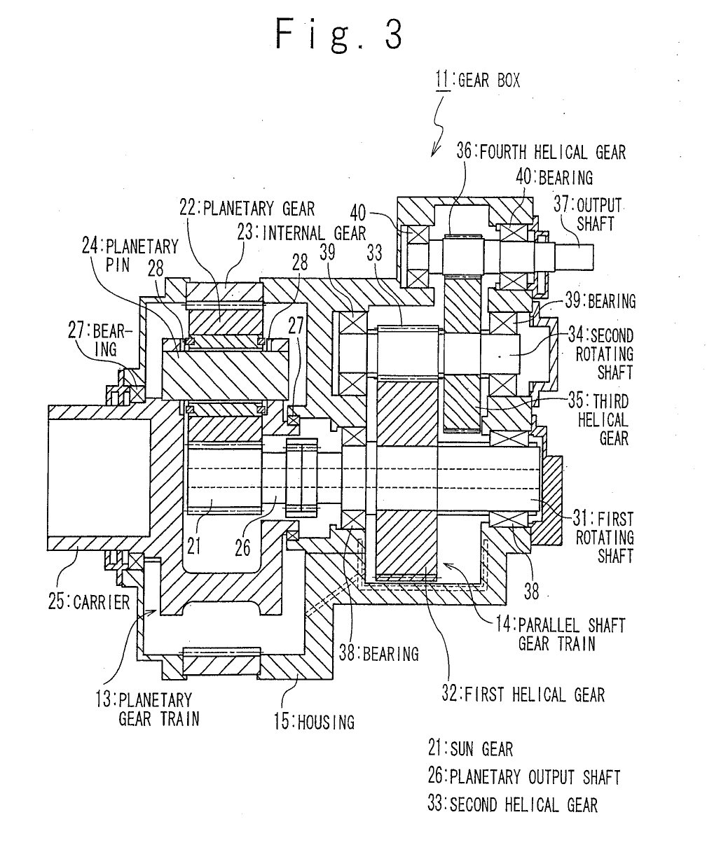

FIG. 3 is a cross sectional view showing the configuration of the gear box 11. The gear box 11 includes a planetary gear train 13, a parallel shaft gear train 14, and a housing 15 accommodating the same. The planetary gear train 13 includes a sun gear 21, a plurality of planetary gears 22 (only one shown), an internal gear 23, a plurality of planetary pins 24 (only one shown), a carrier 25, and a planetary output shaft 26. The planetary gears 22 are positioned between the sun gear 21 and the internal gear 23, and supported by the carrier 25 by the planetary pins 24 inserted into the planetary gears 22. As described below, a sliding bearing is provided on the inner face of the insert hole provided through each planetary gear 22 to allow the planetary gear 22 to rotate with respect to the planetary pin 24. The carrier 25 is rotatably supported by bearings 27 provided on the housing 15, and is used as the input shaft of the planetary gear train 13, that is, the input shaft of the gear box 11. On the other hand, the planetary output shaft 26 is coupled to the sun gear 21 to be used as the output shaft of the planetary gear train 13. When the carrier 25 is rotated, the rotation is transferred to the sun gear 21 via the planetary gears 22, and thus the planetary output shaft 26 connected to the sun gear 21 is rotated at an increased rotation speed.

The parallel shaft gear train 14 includes a first rotating shaft 31 coupled to the planetary output shaft 26, a first helical gear 32 coupled to the first rotating shaft 31, a second helical gear 33, a second rotating shaft 34 coupled to the second helical gear 33, a third helical gear 35 coupled to the second rotating shaft 34, a fourth helical gear 36, and an output shaft 37 coupled to the fourth helical gear 36. The first rotating shaft 31, the second rotating shaft 34, and the output shaft 37 are rotatably supported by bearings 38, 39, and 40 provided on the housing 15, respectively. Moreover, the first helical gear 32 and the second helical gear 33 are engaged with each other, and the third helical gear 35 and the fourth helical gear 36 are engaged with each other. In the parallel shaft gear train 14 having such structure, when the planetary output shaft 26 is rotated, the rotation is transferred to the first helical gear 32, the second helical gear 33, the third helical gear 35, and the fourth helical gear 36, and the output shaft 37 connected to the fourth helical gear 36 is rotated at an increased rotation speed. That is, the gear box 11 provides a step-up of the rotation of the carrier 25 by using the planetary gear train 13 and the parallel shaft gear train 14 when the carrier 25 is rotated, and the resultant rotation is outputted from the output shaft 37.

In the planetary gear train 13 of this embodiment, sliding bearings are provided on the inter faces of the planetary gears 22, and the planetary gears 22 are rotatably supported by the planetary pins 24 with the sliding bearings. Although use of a sliding bearing is effective for increasing the bearable load and the lifetime, a sliding bearing having a large bearable load has a restriction in the formable shape as described above. One feature of the planetary gear train 13 of this embodiment is use of a structure which allows assembly of sliding bearings having a restriction in the formable shape onto the planetary gears 22. The structure of the planetary gears 22 will be explained below in detail.

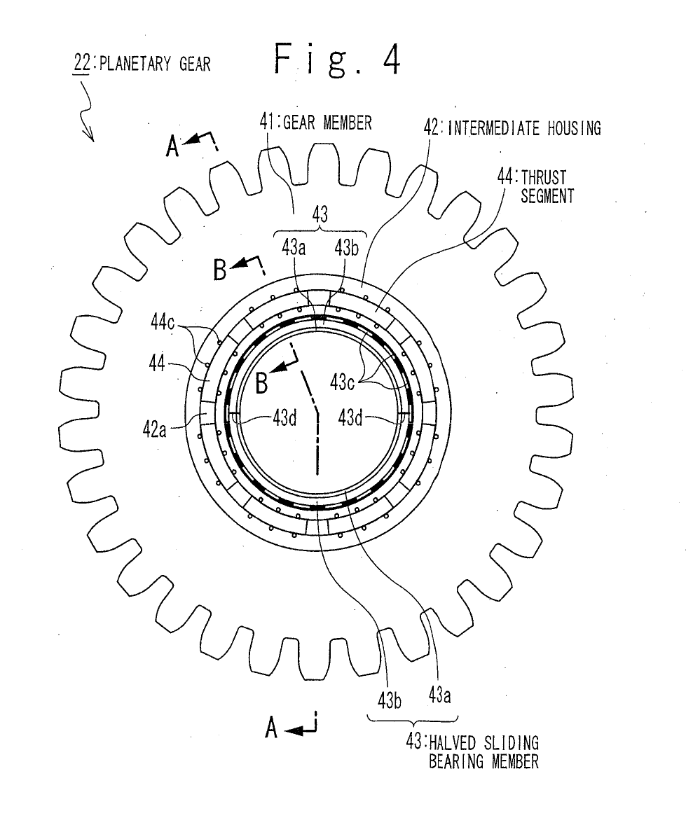

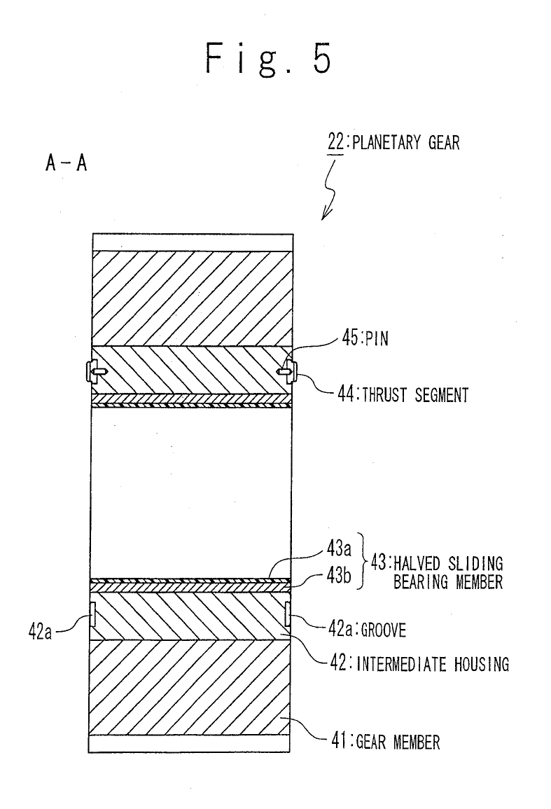

FIG. 4 is a front view showing the structure of a planetary gear 22 in this embodiment, and FIG. 5 is the cross sectional view thereof. The planetary gear 22 schematically includes: a gear member 41 having teeth formed on the outer face; an intermediate housing 42 which is a distinct member from the gear member 41; and a pair of halved sliding bearing members 43 which have a half cylindrical shape. A cylindrical sliding bearing is formed by jointing the halved sliding bearing members 43 having the half cylindrical shape at the end faces 43d. A planetary pin 24 is inserted into the sliding bearing.

In this embodiment, the halved sliding bearing members 43 have a structure in which a surface layer 43a made of resin material (for example, the PEEK material) is backed up by a back metal 43b. Since the structure in which a surface layer made of resin material is backed up by a back metal is hard to be formed in a cylindrical shape as discussed above, a structure in which the sliding bearing is divided into a pair of halved sliding bearing members 43 having the half cylindrical shape is employed in this embodiment.

In order to assemble the halved sliding bearing members 43 into the planetary gear 22, the following structure is employed: A through hole is provided through the gear member 41, and the intermediate housing 42 is fitted into the through hole. In this embodiment, the intermediate housing 42 is fitted into the through hole of the gear member 41 with shrink fitting so that the intermediate housing 42 is detachable from the gear member 41. The halved sliding bearing members 43 are jointed onto the inter face of the intermediate housing 42. In this embodiment, the back metal 43b of the halved sliding bearing member 43 is welded onto the intermediate housing 42 with laser-spot welding. In FIG. 4, welded positions at which the back metal 43b is welded onto the intermediate housing 42 are denoted by reference numerals 43c.

Additionally, a thrust bearing is attached to a surface opposed to the carrier 25 of the intermediate housing 42, in this embodiment. Specifically, a circular groove 42a is formed on the surface opposed to the carrier 25 of the intermediate housing 42, and a plurality of thrust segments 44 of circular arc are circumferentially arranged, more specifically, arranged in the groove 42a at regular intervals in the circumferential direction. On the other hand, as illustrated in FIG. 3, ring-shaped thrust collars 28 are provided on the surfaces opposed to the planetary gear 22 of the carrier 25, and the planetary pin 24 is inserted into the thrust collars 28. The thrust segments 44 and the thrust collars 28 form a thrust bearing for supporting the planetary gear 22 in the thrust direction. In this embodiment, sixteen thrust segments 44 are formed. The thrust segments 44 are arranged to be separated from one another. It is advantageous that the thrust segments 44 are separated from one another from the aspect of providing a path for supplying or ejecting lubricant oil to or from a space between the halved sliding bearing members 43 and the planetary pin 24. In this structure, a clearance between adjacent thrust segments 44 serves as a path through which the lubricant oil flows.

It should be noted that the thrust collars 28 are not necessarily required as components of the thrust bearing. Instead of providing the thrust collar 28, portions of the carrier 25 opposed to the thrust segments 44 may be polished.

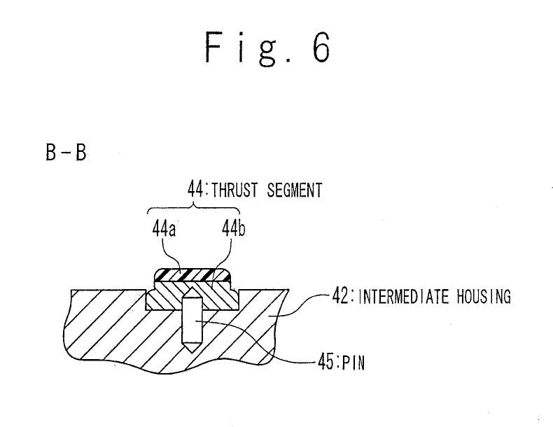

FIG. 6 is a partial cross sectional view showing the structure for attaching the thrust segments 44 onto the intermediate housing 42. The thrust segments 44 include a surface layer 44a formed of resin material (for example, PEEK material) and a back metal 44b; the thrust bearing is configured as the sliding bearing. Each thrust segment 44 is positioned by embedding a pin 45 into the intermediate, housing 42 and into the thrust segment 44, and fixed by caulking the intermediate housing 42 against the thrust segment 44. In FIGS. 4 and 6, portions of the intermediate housing 42 deformed by the caulking are denoted by reference numerals 44c. The thrust segments 44 are prevented from separating from the intermediate housing 42 by caulking the intermediate housing 42. In addition, holes are provided on the bottom surface of the groove 42a of the intermediate housing 42 and on the rear surfaces of the thrust segments 44, and the pins 45 are embedded in the holes. In this manner, the thrust segments 44 are prevented from moving in the circumferential direction.

It is important to employ the structure in which the intermediate housing 42 is assembled onto the gear member 41 with the halved sliding bearing members 43 assembled onto the intermediate housing 42; the halved sliding bearing members 43 are not directly assembled onto the gear member 41. The halved sliding bearing members 43 of the half cylindrical shape cannot be directly assembled onto the gear member 41 with shrink fitting. Meanwhile, the sliding bearing cannot be replaced and heat is partially applied to the gear member 41 to cause thermal deformation of the gear member 41, if the halved sliding bearing members 43 of the half cylindrical shape are directly welded to the gear member 41. In this embodiment, the thermal deformation of the gear member 41 is avoided and the halved sliding bearing members 43 are replaceable by employing the structure in which the intermediate housing 42, which is detachable from the gear member 41, is inserted between the gear member 41 and the halved sliding bearing member 43.

The insertion of the intermediate housing 42 is also preferable in terms of reduction in the TAT (turn-around-time) of the manufacture of a planetary gear 22. The structure in which the halved sliding bearing members 43 and the thrust segments 44 are attached onto the intermediate housing 42, which is a distinct member from the gear member 41, allows carrying out the steps of forming teeth around the gear member 41 and attaching the halved sliding bearing members 43 and the thrust segments 44 onto the intermediate housing 42 in parallel. This effectively reduces the TAT of the manufacture of the planetary gear 22.

As thus described, the planetary gear train 13 of this embodiment adopts the structure in which the intermediate housing 42 is assembled onto the gear member 41 with the halved sliding bearing members 43 assembled onto the intermediate housing 42. This achieves a structure for assembling the sliding bearing having a restriction in the formable shape as the bearing of the planetary gear.

It should be noted that although embodiments of the present invention are specifically described in the above, the present invention may be implemented with various modifications obvious to the person skilled in the art. For example, although the sliding bearing includes a pair of halved sliding bearing members 43 in this embodiment, the sliding bearing may include three or more sliding bearing members divided in the circumferential direction. In addition, although embodiments are presented in which the planetary gear train is applied to the gear box 11 of the wind turbine generator 1 in the above, the planetary gear train of the present invention may be preferably applied also to other power machineries in which a large load is applied to a planetary gear.

What is claimed is:

1. A planetary gear train, comprising:
a planetary gear; and
a planetary pin inserted into said planetary gear,
wherein said planetary gear includes:
a gear member having teeth formed on an outer face thereof and provided with a through hole;
an intermediate housing inserted into said through hole and provided with an insert hole into which said planetary pin is inserted; and
a plurality of sliding bearing members jointed onto said insert hole of said intermediate housing, and
wherein said plurality of sliding bearing members form a sliding bearing which sustains said planetary pin and said planetary gear to be rotatable with each other.

2. The planetary gear train according to claim 1, wherein said intermediate housing and said sliding bearing member are jointed so as not to be detachable, and
wherein said planetary gear and said intermediate housing are jointed so as to be detachable.

3. The planetary gear train according to claim 2, wherein said intermediate housing and said sliding bearing member are welded, and
wherein said planetary gear and said intermediate housing are jointed with shrink fitting.

4. The planetary gear train according to claim 1, further comprising a carrier connected to said planetary pin,
wherein said intermediate housing includes at least one thrust pad serving as a thrust bearing provided on a surface opposed to said carrier.

5. The planetary gear train according to claim 4, wherein the number of said at least one thrust pad is two or more, and
wherein said thrust pads are circumferentially arranged to be separated from each other.

6. A bearing structure, comprising:
an intermediate housing to be inserted into a through hole provided through a gear member having teeth formed on an outer surface thereof and having an insert hole into which a pin is inserted; and
a plurality of sliding bearing members jointed onto said insert hole of said intermediate housing,
wherein said plurality of sliding bearing members form a sliding bearing.

7. The bearing structure according to claim 6, wherein said intermediate housing and said sliding bearing member are jointed so as not to be detachable, and
wherein said planetary gear and said intermediate housing are jointed so as to be detachable.

8. The bearing structure according to claim 6, wherein said plurality of sliding bearing members include:
a surface layer made of resin material; and
a back metal backing up said surface layer.

9. The bearing structure according to claim 6, wherein said intermediate housing includes at least one thrust pad serving as a thrust bearing.

10. A wind turbine generator, comprising:
a wind turbine rotor including a rotor head and a wind turbine blade coupled to said rotor head;
a gear box including an input shaft jointed to said rotor head; and
a generator jointed to an output shaft of said gear box,
wherein said gear box includes a planetary gear train,
wherein said planetary gear train includes a planetary gear; and a planetary pin inserted into said planetary gear,
wherein said planetary gear includes:
a gear member having teeth formed on an outer surface thereof and provided with a through hole;
an intermediate housing inserted into said through hole and provided with an insert hole into which said planetary pin is inserted; and
a plurality of sliding bearing members jointed onto said insert hole of said intermediate housing and arranged in a circumferential direction of said planetary pin, and
wherein said plurality of sliding bearing members form a sliding bearing which sustains said planetary pin and said planetary gear to be rotatable with each other.

11. A manufacture method of a planetary gear having a structure in which a planetary pin is inserted through an insert hole of a planetary gear train, said method comprising steps of:
providing an intermediate housing through which said insert hole is provided;
jointing a plurality of sliding bearing members onto said insert hole of said intermediate housing, said sliding bearing members forming a sliding bearing; and
fitting said intermediate housing into a through hole of a gear member having teeth on an outer face thereof.

12. The manufacture method according to claim 11,
wherein said intermediate housing and said sliding bearing member are jointed so as not to be detachable, and
wherein said planetary gear and said intermediate housing are jointed so as to be detachable.

13. The manufacture method according to claim 12, wherein said intermediate housing and said sliding bearing member are welded, and
wherein said planetary gear and said intermediate housing are jointed with shrink fitting.
